(19) United States
(12) Patent Application Publication
(10) Pub. No.: US 2006/0247563 A1
(43) Pub. Date: Nov. 2, 2006

(54) Tool for manipulating the patella and patellar tendon

(76) Inventors: Dennis W. Martin, Aurora, CO (US); Brian D. Kothe, Centennial, CO (US); Darrel R. Martin, Milliken, CO (US)

Correspondence Address: IAN RICHARD WALSWORTH, 2300 15TH STREET, SUITE 320, DENVER, CO, 80202, US

(21) Appl. No.: 11/475,665

(22) Filed: Jun. 27, 2006

Related U.S. Application Data
(63) Continuation-in-part of application No. 10/847,156, filed on May 17, 2004.

(51) Int. Cl. A61H 7/00

(52) U.S. Cl. 601/135

(57) ABSTRACT

A tool for manipulating and mobilizing the patella and patellar tendon following injury to the knee or surgery thereon to reduce pain, reduce the formation of scar tissue about the patella and eliminate stiffness and loss of range of motion of the knee, is formed by a rigid member having a first end, a second end and an elongated portion extending between the ends. The elongated portion has a central section intermediate the ends defining a V-shaped notch, including a convex portion extending outward from said central section on at least one side of said elongated portion between said ends. A first end defines a generally triangular flattened blade having a lateral arcuate edge of a first profile. A second end defines a generally triangular flattened blade having a lateral arcuate edge of a second profile different from said first profile. A method for using the tool is also described.

### PARENT CASE INFORMATION

This application is a Continuation-in-part of U.S. application Ser. No. 10/847,156 filed Mar. 17, 2004, the disclosure of which is incorporated herein by reference.

### BACKGROUND OF THE INVENTION

1. Field of the Invention (Technical Field)

The present invention relates to physical therapy tools, and more particularly to a tool for manipulating and mobilizing the patella and patellar tendon following injury or knee surgery.

2. Background Art

Tools and methods for soft tissue massage therapy are shown in U.S. Pat. Nos. 5,231,977, 5,366,437, 5,441,478, 5,707,346 and 6,126,620 to Graston. These tools are used by a therapist or trainer to apply pressure to the skin of a patient for removal of fibrous scar tissue adhesions underlying the skin.

### SUMMARY OF THE INVENTION

The present invention is embodied in a tool for manipulating and mobilizing the patella and patellar tendon following injury to the knee or surgery thereon to reduce pain, reduce the formation of scar tissue about the patella and eliminate stiffness and loss of range of motion of the knee. The tool is formed by an elongated member having a first end, a second end and an elongated portion extending between said ends. The elongated portion has a central section intermediate said ends defining a V-shaped notch. The first end defines a generally triangular flattened blade having a lateral arcuate edge of a first profile. The second end defines a generally triangular flattened blade having a lateral arcuate edge of a second profile different from said first profile. Said central section intermediate said ends further comprises a convex oval-shaped portion extending outward from said central section on at least one planar side of said tool. Said convex oval-shaped portion is proximate to the apex of said V-shaped notch for providing an additional point of contact against the knee or patella or patellar tendon of a person being treated by said tool.

### DESCRIPTION OF THE DRAWINGS

The accompanying drawings, which are incorporated into and form a part of the specification, serve to explain the principles of the invention. The drawings are only for the purpose of illustrating a preferred embodiment of the invention and are not to be construed as limiting the invention. In the drawings:

FIG. 1 is a top plan view of a tool embodying the present invention;

FIG. 2 is a bottom plan view of the tool shown in FIG. 1;

FIG. 3 is a front side elevation view of the tool shown in FIG. 1;

FIG. 4 is a rear side elevation view of the tool shown in FIG. 1;

FIG. 5 is a perspective view of the tool shown in FIG. 1;

FIG. 6 is a partial cross-sectional view A of the tool shown in FIG. 1;

FIG. 7 is a partial cross-sectional view B of the tool shown in FIG. 1.

### DETAILED DESCRIPTION OF THE PREFERRED EMBODIMENTS

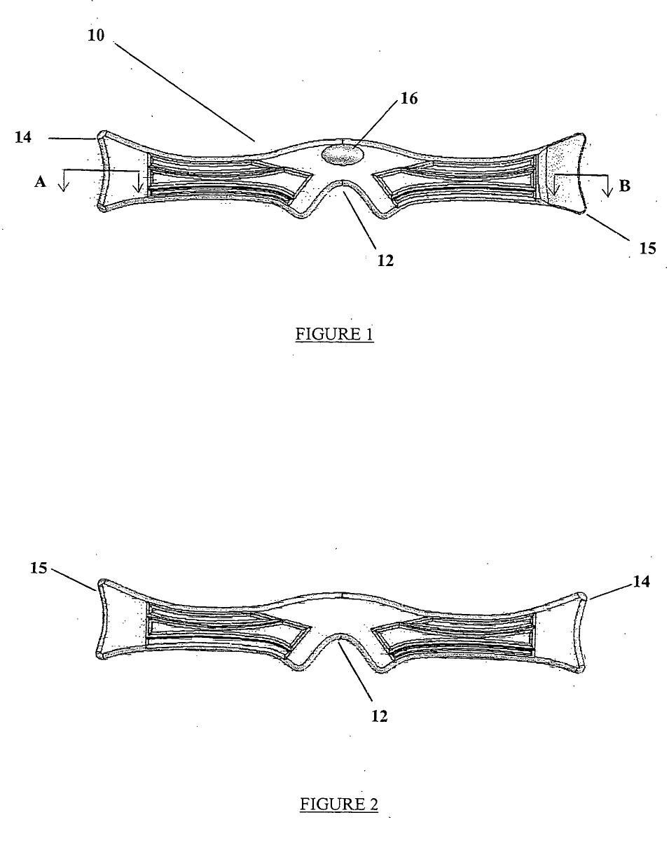

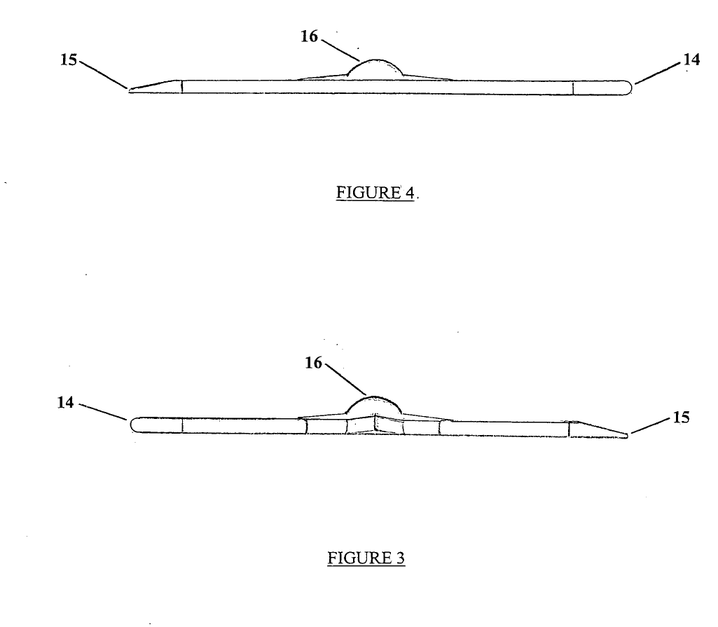

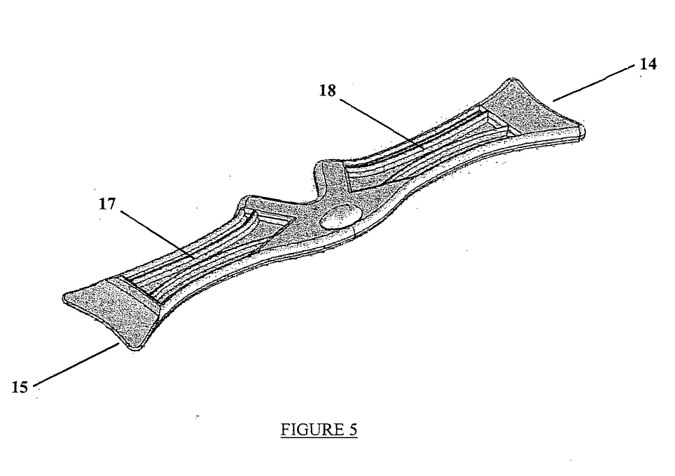

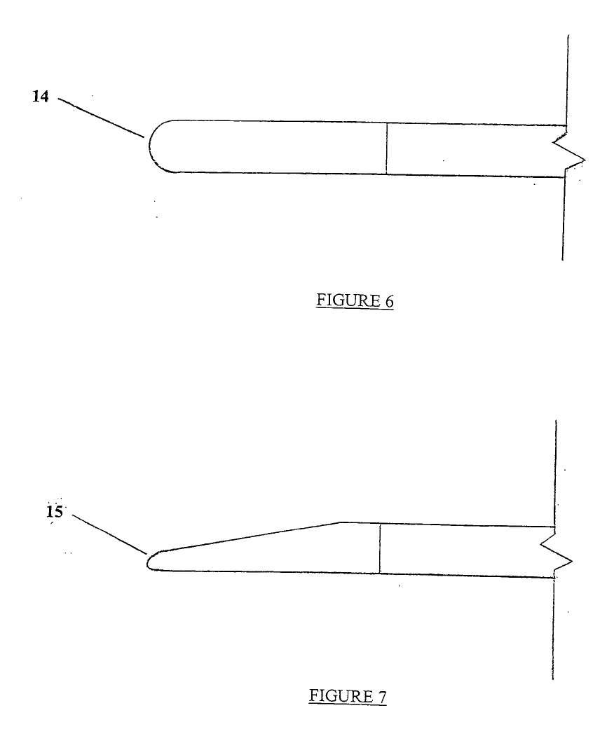

A preferred embodiment of the tool is illustrated in FIGS. 1-7. The present invention is embodied in a tool 10, formed from a rigid material, with two ends 14, 15 and a V-shaped notch 12 formed centrally along an outer contour of the tool as shown in the accompanying drawings. Each end 14, 15 of the tool 10 include blades that are generally triangular in shape, with the outer lateral edge concave arcuate in form. One or more of the lateral edges may be blunt or rounded, or tapered to a narrower profile in order to achieve particular manipulation and mobilization of the patella and patellar tendon.

The central V-shaped notch section 12 and each of the ends 14, 15 may be comprised of a different material than the remainder of the tool 10, and in a preferred embodiment the V-shaped section 12 and ends 14, 15 are comprised of a rubber material. Other materials may be used which may provide a textured or tacky surface to further enhance the ability of a person to manipulate and mobilize the patella and patellar tendon.

In one embodiment of the present invention, the tool 10 is formed of a rigid plastic material approximately ⅜ inches in thickness and approximately 15 inches in length and ranging from approximately 2¾ inches to 1⅝ inches in width. The blade ends 14, 15 are each about 1½ inches long and 2⅝ inches wide at each distal end. The V-shaped notch 12 is approximately 1¼ inches deep with a minimum inner radius. In a preferred embodiment the central section further comprises a convex oval-shaped portion 16 extending outward from said central section on at least one planar side and proximate to the apex of the V-shaped notch 12 to provide another point of contact for manipulating and mobilizing the patella. This point of contact is achieved when the V-shaped notch 12 is engaged with the patient's patella and the tool is laid flat allowing the convex oval-shaped portion 16 to face downward and become positioned against the area above or below the patient's patella, depending on the direction of the V-shaped notch 12. Manipulation and mobilization of the patella and patellar tendon may thus be achieved by the person gripping the tool 10 at or near both ends 14, 15 and pulling the tool 10 towards the patient's body (inferior pole placement) or pushing the tool 10 away from the patient's body (superior pole placement).

The tool 10 described above is designed to manipulate and mobilize the patella, or knee-cap, and the patellar tendon which connects the patella and the tibia. The patellar tendon is often subjected to trauma secondary to surgery, usually surgery on the anterior cruciate ligament, or cumulative trauma like running or jumping. It is to be expressly understood that other types of trauma, including but not limited to scarring, swelling, or as the result of surgery performed on other ligaments in the region of the patella are contemplated for treatment by the tool in a preferred embodiment. The effected region often becomes engulfed in scar tissue and can become shortened (patellar baja) resulting in pain, stiffness, reduced range of motion and function. A chronically shortened patellar tendon caused by an abundance of scar tissue can have devastating effects on the articular cartilage at the end of weight bearing bones behind the patella. Manipulation and in particular mobilization using the tool 10 has an improving effect on reducing pain, reducing the formation of scar tissue about the patella and eliminating stiffness and loss of range of motion to the knee of the patient.

One of the functions of the triangular patella blades 14, 15 is to place a blade on the superior (top) pole of the patella and push or drive the patella inferiorly or in a downward direction. Such inferior patella mobilization lengthens the quadriceps tendon as well as underlying plicae. To perform a lateral patella glide, a blade 14, 15 is placed alongside the patella and a force is applied to drive the patella laterally. This lateral patella glide lengthens the medial (inside) capsular tissues and loads the lateral retinaculum. A medial patella glide can be performed in a similar manner by placing a blade 14, 15 on the lateral or outside border of the patella and driving the patella medially inside.

Further, while holding a blade 14, 15 on the medial border and performing a lateral patellar glide, the lateral or outside border of the patella may be manually lifted to place an aggressive stretch on the lateral retinaculum. This technique is enhanced by using the tapered blade 15 of FIG. 7.

The V-shaped notch 12 or bend is used to perform a superior or upward longitudinal patellar glide. The apex of the V-shaped notch 12 is placed just above the inferior pole of the patella. The area where the notch 12 tapers into the shaft of the tool is placed just off either side of the inferior pole of the patella, making firm contact with the side of the patella, and the tool 10 may be pulled upwardly to perform the superior patella glide. The superior patella mobilization lengthens the patellar tendon and underlying fat pad. Either medial or lateral patellar tendon mobilization or glide serves to loosen tethered tendon and fat pad tissue from the underlying tibial plateau. This provides an open anterior interval (the space between the patellar tendon and tibial plateau). The manipulation and mobilization will increase knee flexion and extension of the knee, so that patients can achieve improved comfort and increased range of motion. Further, the tool in a preferred embodiment will help patients who have poor neuromuscular quadraceps control. By manipulation and mobilization of the patella patients experience less pain or pressure in the front of their knee that is produced by anterior interval scar tissue. Thus, they have increased ability to control the quad muscle following this procedure.

The use of the tool 10 to perform a patellar tendon mobilization or glide on a patient takes stress of the hands of the user performing the technique. The patient's knee may be straight or in various degrees of knee flexion or bending. The arcuate contour of a blade 14, 15 fits nicely into the crease of the user's elbow. This allows a comfortable purchase point for the care provider while using the opposite end of the tool 10 to perform the desired mobilization of the patella and patellar tendon.

In a preferred embodiment, the textured or tacky grip of the material on the blades 14, 15 and V-shaped portion 12 allows a firm, secure and comfortable purchase onto the patella and or patellar tendon. This ability is enhanced by the three independent purchase points provided by the two sides of the V-shaped notch 12 and the convex oval-shaped portion 16 proximate thereto. The primary goal of the tool 10 is to mobilize the patella and maintain the patella mobility. It utilizes a dry mobilizing technique with no ointments or lotions. Furthermore, the tool 10 is designed to avoid blunt pressure on inflamed soft tissue about the knee, and in particular avoid contact with scar tissue that may be present above the patella as a result of surgery thereon.

The tool 10 may be formed in a variety of cross-sectional configurations. In a preferred embodiment the tool 10 includes rib elements 17, 18 between the ends 14, 15 and the central intermediate section to enhance the structural integrity of a tool 10 made from a plastic material. These rib elements 17, 18 may be eliminated by the use of more resilient plastic or polymer material, such as a glass filled polymer or structural polyurethane. The basic criterion is to avoid injury to the patient during manipulation and in particular mobilization of the patella and patellar tendon. The tool 10 may, in various configurations described above, be utilized by a trainer or therapist, as well as by a patient in an in-home environment.

Various applicable equivalents will be appreciated by those in the therapeutic arts. It is to be expressly understood that this descriptive embodiment is provided herein for explanatory purposes only and is not meant to unduly limit the claimed inventions. Other embodiments of the present invention are considered to be within the scope of the claimed inventions, including not only those embodiments that would be within the scope of one skilled in the art, but also as encompassed in technology developed in the future.

As will be understood by those familiar with the art, the present invention may be embodied in other specific forms without departing from the spirit or essential characteristics thereof. For example, the present invention is not limited to a particular shape, size, cross-section or contour for accomplishing the objectives described above, nor is the invention limited to particular materials. The present invention may be used in conjunction with a variety of different treatment methods to the patella and patellar tendon, and one skilled in the art will appreciate the ability of the tool in a preferred embodiment to accomplish a number of varying manipulation and mobilization techniques. Accordingly, the disclosure of the preferred embodiment of the invention is intended to be illustrative, but not limiting, of the scope of the invention which is set forth in the following claims.

What is claimed is:

1. A tool for manipulating and mobilizing the patella and patellar tendon following injury to the knee or surgery thereon to reduce pain, reduce the formation of scar tissue about the patella and eliminate stiffness and loss of range of motion of the knee, comprising:
an elongated member having a first end, a second end and an interior portion extending between said ends;
said interior portion having a central section intermediate said ends defining a V-shaped notch;
said first end defining a generally triangular flattened blade having a lateral arcuate beveled edge;
said second end defining a generally triangular flattened blade having a lateral arcuate tapered edge; and
said central section having a convex portion extending outward from the surface of said central section intermediate said ends proximate to said V-shaped notch.

2. The tool of claim 1 wherein said central section intermediate said ends and said first end and said second end are comprised of rubber.

3. The tool of claim 1 wherein said tool is comprised of plastic.

4. The tool of claim 1 wherein said V-shaped notch and said convex portion engage the patella at three points on the superior pole.

5. The tool of claim 1 wherein said V-shaped notch and said convex portion engage the patella at three points on the inferior pole.

6. A tool for manipulating and mobilizing the patella and patellar tendon following injury to the knee or surgery thereon to reduce pain, reduce the formation of scar tissue about the patella and eliminate stiffness and loss of range of motion of the knee, comprising:
an elongated member having a central intermediate section defining a V-shaped notch;
said central intermediate section having a convex portion extending outward from the surface of said central intermediate section proximate to said V-shaped notch.
one of said ends defining a generally triangular flattened blade having a lateral arcuate beveled edge; and
the other of said ends defining a generally triangular flattened blade having a lateral arcuate tapered edge.

7. The tool of claim 6 wherein said central section intermediate said ends and said first end and said second end are comprised of rubber.

8. The tool of claim 6 wherein said tool is comprised of plastic.

9. The tool of claim 6 wherein said V-shaped notch and said convex portion engage the patella at three points on the superior pole.

10. The tool of claim 6 wherein said V-shaped notch and said convex portion engage the patella at three points on the inferior pole.
